(19) United States
(12) Patent Application Publication
(10) Pub. No.: US 2015/0347348 A1
(43) Pub. Date: Dec. 3, 2015

(54) SMART CONNECTOR FOR ELECTRONIC COMPONENTS

(71) Applicant: QFusion Labs, LLC, Vallejo, CA (US)

(72) Inventor: Jason Gouw, Vallejo, CA (US)

(21) Appl. No.: 14/728,098

(22) Filed: Jun. 2, 2015

Related U.S. Application Data
(60) Provisional application No. 62/007,206, filed on Jun. 3, 2014.

(51) Int. Cl. G06F 13/42

(52) U.S. Cl. CPC G06F 13/4286; G06F 13/4221

(57) ABSTRACT

A cable connector has an integrated computer-based controller. The integrated computer-based controller is configured to receive signals from the electronic component, and to scale the signals into a format compatible with a system controller, as well as to receive signals from the system controller, and to scale the signals into a format compatible with the electronic component.

### CROSS REFERENCE

This application claims priority from U.S. Provisional Patent Application No. 62/007,206, filed Jun. 3, 2014, which is incorporated by reference herein in its entirety.

### TECHNICAL FIELD

This disclosure relates generally to embedded computer systems, and more particularly, to a cable connector having an integrated microcontroller that reads and scales signals communicated between a connected electronic components and an embedded computer system.

### BACKGROUND

Computer-based systems have become ubiquitous in modern society, from the industrial and commercial use of supercomputers and mainframe computers, to the business and personal use of desktop computers, laptops, tablets and smartphones. Further, it has recently become desirable to connect many different types of discrete electronic components to a computer-based system in order to realize digital control and monitoring of a multitude of components, from industrial components such as sensors and stepper motors, to home automation tasks. However, many such components do not have a standardized means for interconnection with a computer-based system.

A general purpose computer system, such as a desktop computer, provides capacity and support for a wide variety of programmed applications. A typical general purpose computer system has a processor and related electronics, such as memory, operating system, I/O, etc., affixed in a box, and accessible through input devices, such as monitor, keyboard, mouse, joystick, as well as to other peripheral devices, such as printer, camera, modem, etc. Further, communication and connection standards for most computer-related peripherals have been long established.

The current interconnection standard for computer devices is the universal serial bus (“USB”). The USB standard defines communication protocols for supplying data and power signals between computers and connected computer peripherals, such as keyboards, printers, cameras, disk drives, etc. USB connections have effectively replaced earlier standard interfaces, such as the RS232 serial interface and the IEEE 1284 parallel interface, as well as separate power chargers for many portable electronic devices.

The USB architecture consists of a host computer having one or more USB ports, with one or more computer peripheral devices connected directly to one of the host USB ports or through a tiered-hub structure. A USB cable uses a different kind of connector on each end, typically referred to as an A-type connector (for the power connection) and a B-type connector (for data and signals).

In contrast to a general purpose computer system, an embedded computer system is an application-specific, single function device, usually integrated with a single product, where one or more programs are executed repeatedly in order to customize the embedded computer for a single application. Common examples of embedded computer systems include digital watches, microwave ovens, digital video recorders, automobiles, and many others. However, one of the downsides of application-specific embedded systems is the lack of a standardized means for connection to computer-based systems.

Therefore, it would be desirable to have a “smart” connector capable of adapting and interconnecting with virtually any remote electronic device.

### BRIEF DESCRIPTION OF THE DRAWINGS

FIG. 1 is a block diagram illustrating an embedded system coupled to a discrete electronic component by a connector.

FIG. 2 illustrates an alternate embodiment of the connector between the embedded system and the discrete electronic component.

FIG. 3 is a block diagram illustrating multiple discrete electronic components coupled to an embedded system controller.

FIG. 4 is a visual flow diagram illustrating a simple program for blinking an LED.

FIG. 5 is a visual flow diagram illustrating a simple program for providing temperature control of a fan.

FIGS. 6A and 6B illustrate a top plan view and a side plan view, respectively, of multiple embedded system controllers linked together in a vertical stack.

### DETAILED DESCRIPTION

This disclosure describes a system and method for interconnecting any type of discrete electrical component to a computer-based system using a connector having an embedded programmable computer-based controller.

The USB standard is well-established for cables, connectors, and communication protocols between computers and computer peripherals. However, there are many electronic components that do not adhere to the USB standard, for example, because they have analog inputs and/or outputs having an operating range beyond that of the USB protocol, and computer connection to such components typically requires a custom solution.

The present disclosure describes a cable connector having an embedded computer-based controller that can be programmed to recognize and scale input and/or output signals for a connected electronic component, in order to communicate with the host computer system through a standardized connection, such as USB.

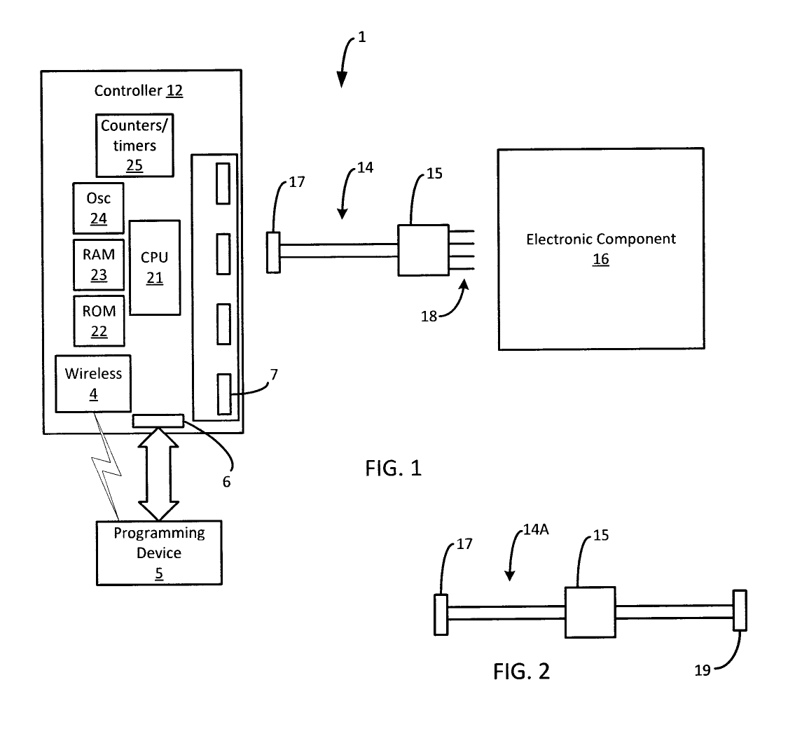

FIG. 1 illustrates a system 1 having an embedded system controller 12 coupled to an electronic component 16 by a cable connector 14. The controller 12 includes multiple input/output (“I/O”) ports 7 for connecting multiple electronic components to the controller. In one embodiment, a separate programming port 6 can be provided for connecting a programming device 5 to the controller 12. In another embodiment, ports 6 and 7 are both identically configured for serial-to-USB communication. Optionally, the controller 12 may be configured for wireless communication with the programming device 5 via a wireless communication module 4, for example, using Bluetooth or other wireless technologies and protocols.

In one embodiment, the controller 12 is a microcontroller system, such as the Cubit Programmable Controller made by QFusion Labs, or an Arduino microcontroller, or a Rasberry Pi single-board computer, or any similar application specific programmable system. Such a system is typically based on a dedicated microcontroller chip, such as the PIC series 32-bit microcontroller chip made by Microchip Technology (also available in 8-bit and 16-bit configurations). As with any processor-based device, the microcontroller has a central processing unit (“CPU”) 21 for loading and executing programs, a read-only memory (“ROM”) 22 for storing program instructions, and a random-access memory (“RAM”) 23 for storing program variables. Further, the microcontroller includes a crystal oscillator 24 for timing and synchronization and a counters/timers module 25 for performing basic operations.

The cable connector 14 is a multi-conductor electrical cable that includes a standardized connector 17, such as a USB connector, integrated at one end of the cable connector. For example, the connector 17 is a male plug that couples with a corresponding female receptacle configured at the I/O ports 7 of the controller 12.

A second microcontroller 15, e.g., a PIC series 8-bit microcontroller, is integrated at the other end of the cable connector 14. The second microcontroller 15 is typically programmed with instructions prior to integration with the cable, and thus, the program code is generally not available to the user. However, it is possible to store uncompiled code and to have the code compiled every time the system is powered on. This feature would give the user the ability to access and change the code as desired.

Extending from the connector-embedded microcontroller 15 are wire leads 18 for connection to corresponding wiring (not shown) of the electronic component 16. The number and type of wire leads 18 depend upon the application and the connected component.

An alternative cable connector 14A is shown in FIG. 2, where the wire leads 18 are resolved into a molded cable and connector 19 compatible with a similar connector on the connected component. For example, a different molded cable and connector 19 can be provided for any number of different connection configurations, such as components that use the Inter-Integrated Circuit (“I²C” or “I2C”) serial bus, or the Serial Peripheral Interface (“SPI”), as further described below.

The connector-embedded microcontroller 15 can be programmed to recognize and scale inputs and/or outputs to facilitate communication between the system controller 12 and the connected component 16, as further explained below.

The electronic component 16 can be any analog or digital electronic device, including servos, stepper motors, LEDs, LCD displays, pushbuttons, electronic sensors, potentiometers, etc. For example, common ranges for analog variables include 0 to 20 ma, 4 to 20 ma, 0 V to 5V, 0 V to 10 V, +/−5V, and +/−10 V. Thus, since USB connections cannot handle such widely varying inputs, the connected-embedded microcontroller 15 is configured to transform the signals so that they may be transmitted through the USB connector to the system controller 12. For example, the microcontroller has an analog to digital conversion unit that can be used to scale a signal received from the connected device, or sent to the connected device. Other component specific signals can similarly be generated. However, it should be clear that the electronic components of interest here are not computer peripherals of the type that are configured to be connected directly to a computer system, e,g, by a standard USB connector, such as keyboards, printers, disk drives, etc. Instead, the electronic components of interest are not capable of being driven directly by a computer system, for example, because the signal range of the component is not compatible with the USB standard, but instead require a different connection/communication protocol. Advantageously, any number of different connection protocols can be provided by appropriate configuration of the microcontroller 15 integrated with the cable connector 14, as further explained below.

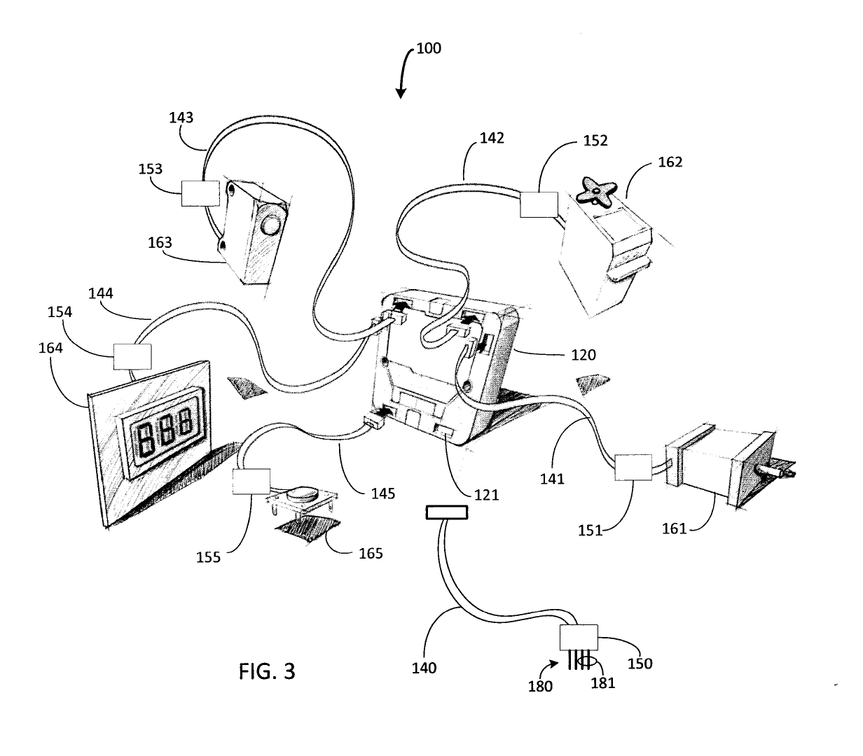

Referring to FIG. 3, one embodiment of an embedded system 100 is illustrated with multiple electronic components each connected to and controlled by a single controller 120 using a “smart” connector cable 140. Controller 120 is a high-end microcontroller device, like the PIC series 32-bit microcontroller or equivalent, having a plurality of general purpose input/output (“GPIO”) ports 121. In one embodiment, the GPIO ports 121 are configured as female receptacles having a plurality of pins (not shown) and adapted to mate with a corresponding male plug. Further, in one embodiment, the GPIO ports 121 conform to the USB standard. Thus, each port 121 is typically configured in the same way, with the pins of the female receptacle interconnected to an internal buffer of the controller 120. Each wire lead is used to communicate electronic signals, including power, ground, data and control signals, between the controller 120 and the connected electronic component. However, each port 121 may be driven differently by the controller 120, depending upon the electronic component that is attached to the port. Further, a programming device may be connected to the controller 120 via one of the ports 121.

As illustrated in FIG. 3, a cable connector 140 having an embedded computer-based controller 150, e.g., a second microcontroller, may be used to connect to a discrete electronic component. For example, a first cable connector 141 with embedded microcontroller 151 couples a stepper motor 161 to a first one of the GPIO ports 121; a second cable connector 142 with embedded microcontroller 152 couples a servo motor 162 to a second GPIO port; a third cable connector 143 with embedded microcontroller 153 couples an electronic sensor 163 to a third GPIO port; a fourth cable connector 144 with embedded microcontroller 154 couples an LCD 164 to a fourth GPIO port; and a fifth cable connector 145 with embedded microcontroller 155 couples a pushbutton 165 to a sixth GPIO port. This example is purely illustrative and not intended to be limiting as to the number of ports that could be configured or the number and type of components that could be connected.

In general, a number of different application-specific cable connectors could be fabricated by customizing the embedded microcontroller 150 in the cable connector 140 for the particular application, i.e., one having different program instructions for each of the differently configured electrical components. For example, a large number of digital devices, especially discrete digital sensors, utilize the Inter-Integrated Circuit (“I²C” or “I2C”) serial bus to connect to a computer system. The I2C bus uses only two bidirectional signal lines, namely a serial data line (“SDL”) and a serial clock line (“SCL”), that are pulled up to the supply voltage with resistors. Typical system voltage ranges from +2 VDC to +5 VDC for such devices. Further, a device connected using the I2C protocol is assigned either a 7-bit or 10-bit address space in the controller for addressing the connected device. The current revisions of the I2C protocol can run bus speeds of 3.4 Mb/s in a high speed mode; 400 kb/s in a fast mode; and 10 kb/s in a low-speed mode. Until now, there has been no standardized computer connector that is useful for devices adhering to the I2C protocol. By customizing the embedded microcontroller 150 for a specific component application, a standard connector for that application can be created.

Further, it is possible to program the microcontroller 150 with a number of different I/O protocols such that a single customized cable connector 140 could provide a standardized connection for a variety of different I/O protocols.

To configure control and communication for any of the electronic components, the system controller 120 is programmed with appropriate instructions to read input from its ports and/or generate outputs at its ports that have been scaled for use with the connected component. Further, the embedded microcontroller 150 of the cable connector 140, for example, is programmed with instructions that scale signals accordingly between the serial USB connection at the system controller 120 and the application requirement of the connected device.

Thus, in order to automatically communicate with an I2C device, a pair 181 of the wires 180 are connected with the SDL and SCL lines of the device, e.g., by soldered connection or molded connector. The connector-embedded microcontroller 150 is programmed to read the DC input voltages on the pair of wires 181, and to scale these signals as required by the controller, e.g., compatible with the USB standard. Other connection configurations, such as RS232 or the SPI, can be similarly adapted and scaling routines programmed.

The use of high level software programming languages to implement control requirements is generally known, and a wide variety of programming tools are available to developers and hobbyists, such as the C programming language and others. The PIC series microcontrollers include the MPLAB Harmony integrated firmware development platform that provides a framework for software development, including libraries, drivers and system services. Thus, a programming device, such as a laptop or desktop computer, can be directly connected to the microcontroller by a USB cable coupled to a GPIO port, or by wireless connection, such as Bluetooth or other wireless protocol.

In one embodiment, a visual programming language may be used to program specific control tasks for the connected electronic component(s), as well as to program the connector microcontroller to translate data as required for the particular application. For example, the Cubit Programmable Controller uses the Lua scripting language to create a library of visual elements that can be used to specify control flow diagrams for connected devices. Upon connecting an electronic component to the controller 120, the controller can be configured to automatically recognize the connected component, and to provide an icon corresponding to the connected component in the visual programming workspace on the programming device. The icon can be configured to provide a number of different functional routines that can be performed with the device.

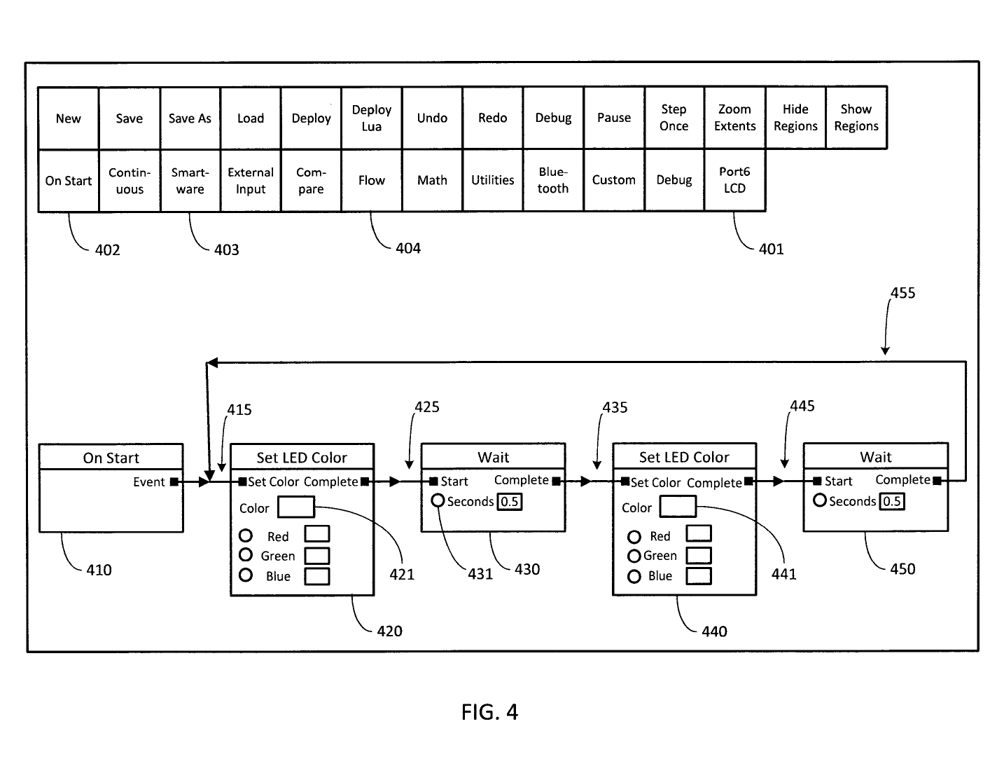

For example, FIG. 4 illustrates one example of a simple visual program for blinking an LED on the controller 120. Block 410 labeled “On Start” is dragged into the workspace from button 402, and will cause the program (when completed) to be launched. Block 420 labeled “Set On Board LED Color” is chosen from button 403 labeled “Onboard Smartware” and dragged into the workspace, and is coupled to block 410 by dragging a wire 415 between the blocks. The color in block 420 can be chosen by a color picker by moving a mouse through color space 421, for example, to choose a red shade. Next, block 430 labeled “Wait” is chosen from button 404 labeled “Flow” and is coupled to block 420 by dragging wire 425 between the blocks. The amount of wait time is entered into box 431, e.g., 0.4 seconds. A second color block 440 is dragged into the workspace and coupled to the output of the wait block 430 by dragging wire 435 between the blocks, and the color green has been selected through color picker 441. A second wait block 450 is coupled to the second color block 440 by dragging wire 445 between the blocks. The output of the second wait block 450 is coupled back to the input of the first color block 420 by dragging a wire 455 from the output of block 450 to the input of block 420. Thus, upon launching the program, e.g., by pressing button 405 labeled “Deploy,” the LED will alternately blink red then blue forever. The program is saved and given a name, such as “Blink LED.”

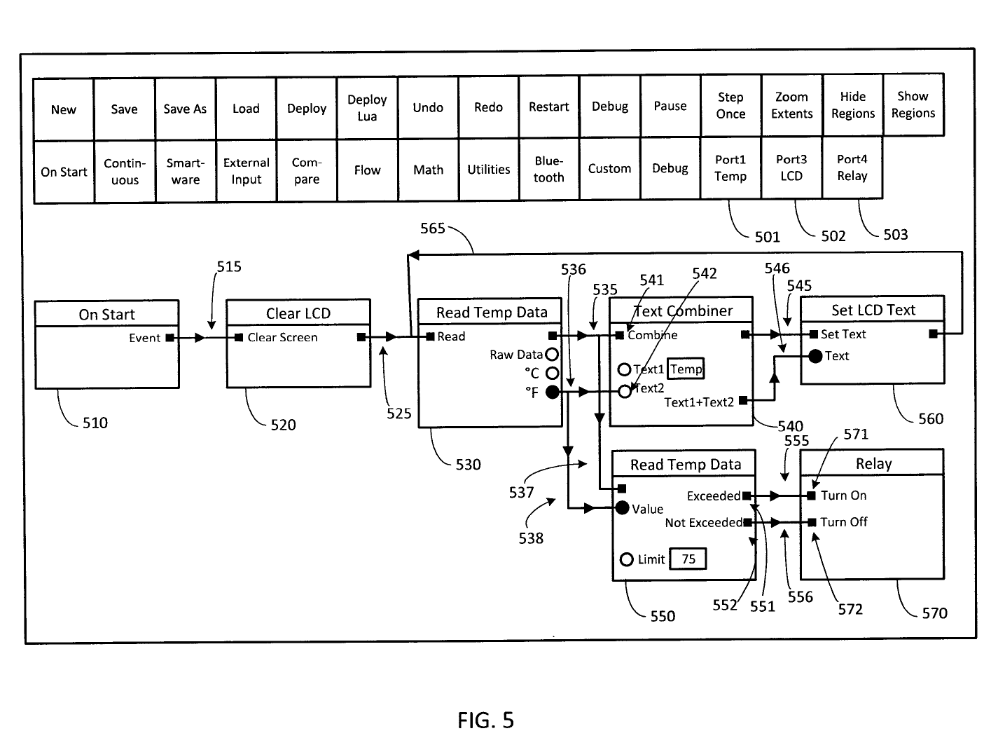

FIG. 5 illustrates one example of a simple visual program for providing temperature control to operate a fan. Three discrete electronic components are connected to the controller, and are automatically recognized within the visual flow workspace. Thus, a temperature sensor is plugged into port 1 of the controller and causes icon 501 to appear in the workspace, labeled “Port1 Temperature,” and several operating parameters of the temperature sensor can be accessed for programming a control flow by selecting the icon. An LCD is plugged into port 3 of the controller and causes icon 502 to appear in the workspace, labeled “Port3 LCD,” and several operating parameters of the LCD can be accessed for programming a control flow by selecting the icon. A relay is plugged into port 4 of the controller and causes icon 503 to appear in the workspace, labeled “Port4 Relay,” and several operating parameters of the relay can be accessed for programming a control flow by selecting the icon.

To program the control flow, a start block 510 is dragged into the workspace. Next, block 520 is selected from choices configured in the LCD icon 502, and block 520 is coupled to the start block 510 by dragging a wire connector 515 between the blocks. Block 520 will clear the LCD of any characters before proceeding. Block 530 is selected from choices configured in the Temperature icon 501, and is dragged onto the workspace and connected to block 520 by dragging wire 525 between the blocks. A text combiner block 540 is dragged onto the workspace, and includes a first input field 541 for entering a first bit of text (text1) and a second input node 542 for coupling the temperature reading from block 530 as text2. Wire 535 couples the output of block 530 into block 540, and wire 536 couples the temperature (in degrees Farenheit) into block 540. Also, block 550 is a block for measuring a threshold value, and wire 537 couples the output of block 530 to block 550 while wire 538 couples the temperature into block 550.

Block 560 is dragged into the workspace and connected to block 540 by wire 545. The combined text from block 540 is connected to block 560 by wire 546, such that the temperature reading from the sensor is displayed on the LCD. Block 570 dragged onto the workspace and is configured to turn the relay on when the temperature exceeds the programmed threshold and to turn the relay off when the temperature drops below the programmed threshold. Block 550 includes node 551 that indicates that the threshold has been exceeded, and node 552 that indicates that the threshold has not been exceeded. Block 570 has node 571 that is connected by wire 555 to node 551 such that when the temperature is exceeded, the relay turns on and the fan is driven. Block 570 also has node 572 that is connected by wire 556 to node 552 such that when the temperature drops below the threshold, the relay turns off and the fan shuts off.

The visual programming of a control flow for a connected peripheral is straightforward for one with ordinary skill in this area, and many different electronic components can be operated and controlled through appropriate programming.

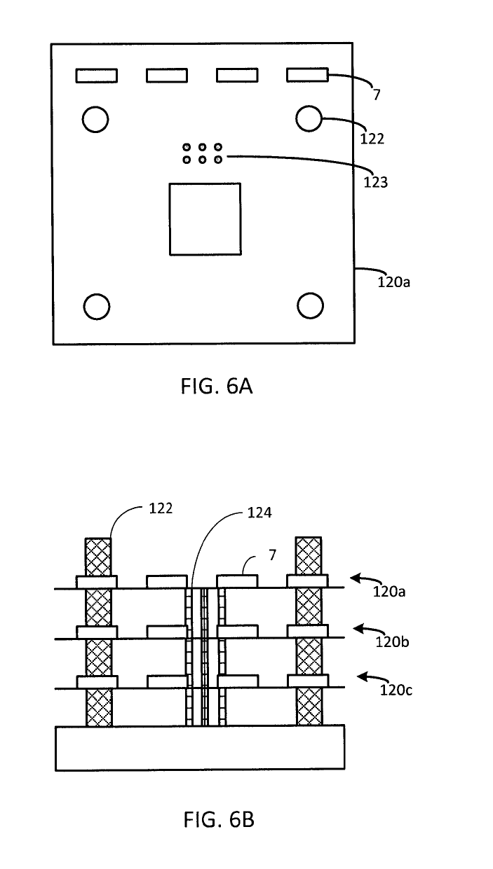

Controller 120 is capable of being stacked or linked with other similar controllers to provide an interface for a much larger number of connected components. For example, FIGS. 6A and 6B illustrate a stack of three controllers 120A, 120B and 120C coupled together such that power and signal pins are connected in a daisy-chain configuration. In one embodiment, each controller includes a number of stand-offs 122 for mounting one controller on top and spaced apart from another controller. In another embodiment, each controller includes through-holes (not shown) for inserting support posts (not shown) through the controller to mount and support additional controllers. A number of contact pads 123 are formed on the top side of the controller, while a plurality of pins 124, e.g. pogo pins, are formed on the bottom side of the controller in electrical correspondence with the contact pads. A pogo pin 124 is a spring-loaded pin affixed on a first controller that makes electrical contact with a corresponding contact pad 123 affixed on a second controller, e.g., the second is positioned below the first controller.

One or more specific embodiments are described herein, but it is to be understood that one or more implementations are not limited to the disclosed embodiments. To the contrary, various modifications and similar arrangements would be apparent to those skilled in the art, and therefore, the scope of the appended claims should be accorded the broadest interpretation so as to encompass all such modifications and similar arrangements.

1. A cable connector, comprising:
a cable having a plurality of conductors;
a first connector adapted to mate with a host computer and coupled at a first end of the cable to at least two of the conductors;
a computer-based controller integrated with a second end of the cable and coupled to the at least two conductors, the computer-based controller configured to receive signals on the cable and to scale the signals into a specified signal format; and
a plurality of wire leads coupled to and extending from the computer-based controller, the wire leads configured to be coupled with an electronic component.

2. The cable connector of claim 1, further comprising:
a second connector formed with the plurality of wire leads to be compatible with a mating connector on the electronic component.

3. The cable connector of claim 1, further comprising:
the computer-based controller is programmed with instructions to receive a first signal from the electronic component, and to scale the first signal into a first format compatible with the host computer.

4. The cable connector of claim 3, further comprising:
the first format is a serial digital format.

5. The cable connector of claim 4, further comprising:
the serial digital format is a USB standard format.

6. The cable connector of claim 1, further comprising:
the computer-based controller is programmed with instructions to receive a second signal from the host computer, and to scale the second signal into a second format compatible with the electronic component.

7. The cable connector of claim 6, further comprising:
the second format is an analog or digital format.

8. The cable connector of claim 7, further comprising:
the analog format is chosen from: 0 to 20 ma; 4 to 20 ma; 0 V to 5V; 0 V to 10 V; +/−5 V; and +/−10 V.

9. The cable connector of claim 3, further comprising:
the computer-based controller is programmed with instructions to receive a plurality of different types of signals from the electronic component, and to scale the different types of signals into the first format compatible with the host computer.

10. The cable connector of claim 6, further comprising:
the computer-based controller is programmed with instructions to receive the second signal from the host computer, and to scale the second signal into a plurality of different formats corresponding to a plurality of different types of electronic components.

11. A cable connector for coupling an embedded system with an electronic component having a specified format for I/O signals, comprising:
a cable having a plurality of conductors extending from a first end of the cable to a second end of the cable;
a first connector coupled to at least two of the conductors at the first end of the cable and configured to electronically couple the at least two conductors with the embedded system;
a computer-based controller integrated with the second end of the cable and coupled to the at least two conductors, the computer-based controller configured to receive signals on the cable and to scale the signals into a specified signal format for communication between the embedded system and the electronic component; and
a plurality of wire leads coupled to and extending from the computer-based controller, the wire leads configured to be coupled with the electronic component.

12. The cable connector of claim 1, further comprising:
a second connector formed with the plurality of wire leads to be compatible with a mating connector on the electronic component.

13. The cable connector of claim 11, further comprising:
the computer-based controller is programmed with instructions to receive a first signal from the electronic component, and to scale the first signal into a first format compatible with the embedded system.

14. The cable connector of claim 11, further comprising:
the computer-based controller is programmed with instructions to receive a second signal from the embedded system, and to scale the second signal into a second format compatible with the electronic component.

15. The cable connector of claim 13, further comprising:
the computer-based controller is programmed with instructions to receive a plurality of different types of signals from the electronic component, and to scale the different types of signals into the first format compatible with the embedded system.

16. The cable connector of claim 14, further comprising:
the computer-based controller is programmed with instructions to receive the second signal from the embedded system, and to scale the second signal into a plurality of different formats corresponding to a plurality of different types of electronic components.

17. An embedded system, comprising:
a first computer-based controller programmed with instructions to communicate with at least one electronic component; and
at least one cable connector having a plurality of conductors and a second computer-based controller integrated with the cable connector and coupled to the conductors, the second computer-based controller programmed with instructions to receive and scale signals on the cable into a specified signal format.

18. The embedded system of claim 17, further comprising:
the second computer-based controller is programmed with instructions to receive a first signal from the electronic component, and to scale the first signal into a first format compatible with the first computer-based controller.

18. The embedded system of claim 17, further comprising:
the second computer-based controller is programmed with instructions to receive a second signal from the first computer-based controller, and to scale the second signal into a second format compatible with the electronic component.

20. The embedded system of claim 17, further comprising:
a plurality of the first computer-based controllers coupled together; and
a plurality of electronic components each coupled by a respective cable connector to one of the first computer-based controllers.
